(19) United States
(12) Patent Application Publication
(10) Pub. No.: US 2026/0230822 A1
(43) Pub. Date: Aug. 6, 2026

(54) METHODS, SYSTEMS, AND COMPUTER READABLE MEDIA FOR PROVIDING FEDERATED NETWORK INTEROPERABILITY IN THE ABSENCE OF ACESSS TOKEN AUTHORIZATION SUPPORT IN THE HOME NETWORK

(71) Applicant: Oracle International Corporation, Redwood Shores, CA (US)

(72) Inventors: John Nirmal Mohan Raj, Bangalore (IN); Ashish Jyoti Sharma, New Delhi (IN); Sonia Ladyan, New Delhi (IN)

(21) Appl. No.: 19/572,833

(22) Filed: Mar. 19, 2026

(51) Int. Cl. H04W 12/08; H04W 12/06

(52) U.S. Cl. CPC H04W 12/08; H04W 12/06

(57) ABSTRACT

A method for providing federated network interoperability in the absence of access token authorization support includes receiving, by a SEPP, an access token request message from a vNRF requesting an access token on behalf of a consumer NF to access a service in a home network. The method further includes storing parameter values from the access token request message. The method further includes forwarding the access token request message to the home network and receiving an error message. The method further includes authorizing the consumer NF, generating, an access token, and transmitting the access token response message including the access token to the visited NRF. The method further includes receiving, from the consumer NF, an inter-PLMN SBI request message including the access token, verifying the access token, removing the access token from the inter-PLMN SBI request message, and forwarding the inter-PLMN SBI request message to the home network.

### TECHNICAL FIELD

The subject matter described herein relates to network security and interoperability. More particularly, the subject matter described herein relates to methods, systems, and computer readable media for providing federated network interoperability in the absence of access token authorization support in the home network.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with a network function repository function (NRF). The NRF maintains profiles of available NF instances identifying the services supported by each NF instance. The profile of an NF instance is referred to in Third Generation Partnership Project (3GPP) Technical Specification (TS) TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that can occur in 5G and other types of networks is the lack of an authorization service when one network, such as a visited network, supports access-token-based authorization and another network, such as a home network, does not support access-token-based authorization. For example, in roaming scenarios, 5G networks are flooded with attacks, such as brute force attacks, denial of service (DoS) attacks, etc. To avoid such attacks, Third Generation Partnership Project (3GPP) Technical Specification (TS) 33.501, Release 17, section 13.4 describes authorization of NF service access by using OAuth 2.0-based authorization. However, there is no mention of authorization of network functions if OAuth is not supported by networks. Accordingly, if a network does not support OAuth 2.0-based authorization, the network may be vulnerable to security attacks.

In light of these and other difficulties, there exists a need for improved methods, systems, and computer readable media for providing federated network interoperability in the absence of access token authorization support in the home network.

### SUMMARY

A method for providing federated network interoperability in the absence of access token authorization support in a home network includes discovering, by a security edge protection proxy (SEPP), network function (NF) profiles of consumer NFs allowed to send inter-public land mobile network (inter-PLMN) service-based interface (SBI) request messages. The method further includes receiving, by the SEPP, an access token request message from a visited NF repository function (NRF) requesting an access token on behalf of a consumer NF to access a service in a home network. The method further includes storing, by the SEPP, parameter values from the access token request message. The method further includes forwarding, by the SEPP, the access token request message to the home network. The method further includes receiving, by the SEPP, from the home network, and in response to the access token request message, an error message. The method further includes authorizing, by the SEPP, the consumer NF. The method further includes generating, by the SEPP, an access token, generating an access token response message, and transmitting the access token response message including the access token to the visited NRF. The method further includes receiving, by the SEPP and from the consumer NF, an inter-PLMN SBI request message including the access token, verifying the access token, removing the access token from the inter-PLMN SBI request message and forwarding the inter-PLMN SBI request message to the home network.

According to another aspect of the subject matter described herein, discovering NF profiles of the consumer NFs allowed to send the inter-PLMN SBI request messages includes sending an NF discovery request message to the visited NRF and receiving an NF discovery response message from the visited NRF including NF profiles of the consumer NFs allowed to send the inter-PLMN SBI request messages.

According to another aspect of the subject matter described herein, the method for providing federated network interoperability includes subscribing, by the SEPP and with the visited NRF, to receive updates to NF profiles of the consumer NFs authorized to send the inter-PLMN SBI request messages.

According to another aspect of the subject matter described herein, receiving the access token request message includes receiving an OAuth2.0 access token request message and generating the access token incudes generating an OAuth2.0 access token.

According to another aspect of the subject matter described herein, storing the parameter values from the access token request message includes storing identification information for the consumer NF in an access token request information cache or database local to the SEPP.

According to another aspect of the subject matter described herein, authorizing the consumer NF includes confirming that the consumer NF is registered with the visited NRF and is one of the consumer NFs authorized to send the inter-PLMN SBI request messages.

According to another aspect of the subject matter described herein, generating the access token includes inserting a client identifier in the access token.

According to another aspect of the subject matter described herein, the method for providing federated network interoperability includes comprising creating the client identifier including information regarding the SEPP, information regarding the consumer NF, and a pseudo-random string.

According to another aspect of the subject matter described herein, the method for providing for federated network interoperability includes validating, by the SEPP, the access token received in the inter-PLMN SBI request message.

According to another aspect of the subject matter described herein, validating the access token includes determining whether the access token includes a client identifier that matches a client identifier created by the SEPP.

According to another aspect of the subject matter described herein, system for providing federated network interoperability in the absence of access token authorization support in a home network includes a computing platform including at least one processor and a memory. The system further includes a SEPP implemented by the at least one processor for discovering network function (NF) profiles of consumer NFs allowed to send inter-public land mobile network (inter-PLMN) service-based interface (SBI) request messages, receiving, an access token request message from a visited NF repository function (NRF) requesting an access token on behalf of a consumer NF to access a service in a home network, storing parameter values from the access token request message, forwarding the access token request message to the home network, receiving, from the home network, and in response to the access token request message, an error message, authorizing the consumer NF, generating, an access token, generating an access token response message, and transmitting the access token response message including the access token to the visited NRF, and receiving, from the consumer NF, an inter-PLMN SBI request message including the access token, verifying the access token, removing the access token from the inter-PLMN SBI request message and forwarding the inter-PLMN SBI request message to the home network.

According to another aspect of the subject matter described herein, the SEPP is configured to discover the NF profiles of the consumer NFs allowed to send the inter-PLMN SBI request messages by sending an NF discovery request message to the visited NRF and receiving an NF discovery response message from the visited NRF including NF profiles of the consumer NFs allowed to send the inter-PLMN SBI request messages.

According to another aspect of the subject matter described herein, the SEPP is configured to subscribe with the visited NRF to receive updates to NF profiles of the consumer NFs authorized to send the inter-PLMN SBI request messages.

According to another aspect of the subject matter described herein, the access token request message comprises an OAuth2.0 access token request message and the generated access token includes an OAuth 2.0 access token.

According to another aspect of the subject matter described herein, the SEPP includes an access token request information cache or database, the SEPP is configured to store the parameter values from the access token request message in the access token request information cache or database, and parameter values from the access token request message include identification information for the consumer NF.

According to another aspect of the subject matter described herein, the SEPP is configured to authorize the consumer NF by confirming that the consumer NF is registered with the visited NRF and is one of the consumer NFs authorized to send the inter-PLMN SBI request messages.

According to another aspect of the subject matter described herein, the SEPP is configured to insert a client identifier in the access token.

According to another aspect of the subject matter described herein, the SEPP is configured to create the client identifier by including, in the client identifier, information regarding the SEPP, information regarding the consumer NF, and a pseudo-random string.

According to another aspect of the subject matter described herein, the SEPP is configured to validate the access token received in the inter-PLMN SBI request by determining whether the access token includes a client identifier that matches a client identifier created by the SEPP.

According to another aspect of the subject matter described herein, a non-transitory computer readable medium having stored thereon executable instructions that when executed by a processor of a computer control the computer to perform steps is provided. The steps include discovering, by a security edge protection proxy (SEPP), network function (NF) profiles of consumer NFs allowed to send inter-public land mobile network (inter-PLMN) service-based interface (SBI) request messages. The steps further include receiving, by the SEPP, an access token request message from a visited NF repository function (NRF) requesting an access token on behalf of a consumer NF to access a service in a home network. The steps further include storing, by the SEPP, parameter values from the access token request message. The steps further include forwarding, by the SEPP, the access token request message to the home network. The steps further include receiving, by the SEPP, from the home network, and in response to the access token request message, an error message. The steps further include authorizing, by the SEPP, the consumer NF. The steps further include generating, by the SEPP, an access token, generating an access token response message, and transmitting the access token response message including the access token to the visited NRF. The steps further include receiving, by the SEPP and from the consumer NF, an inter-PLMN SBI request message including the access token, verifying the access token, removing the access token from the inter-PLMN SBI request message and forwarding the inter-PLMN SBI request message to the home network.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a message flow diagram illustrating an exemplary message exchange when a visited PLMN supports access-token-based-authorization and a home network does not support access-token-based authorization;

FIGS. 3A and 3B are a message flow diagram illustrating the use of a SEPP to provide network interoperability in the absence of access token authorization support in the home network;

FIG. 4 is a diagram of an access token generated by a SEPP on behalf of a home network NRF;

FIG. 5 is a block diagram illustrating an exemplary architecture for a SEPP that provides federated network interoperability in the absence of access token authorization support in the home network; and

FIG. 6 is a flow chart illustrating an exemplary process for providing federated network interoperability in the absence of access token authorization support in the home network.

### DETAILED DESCRIPTION

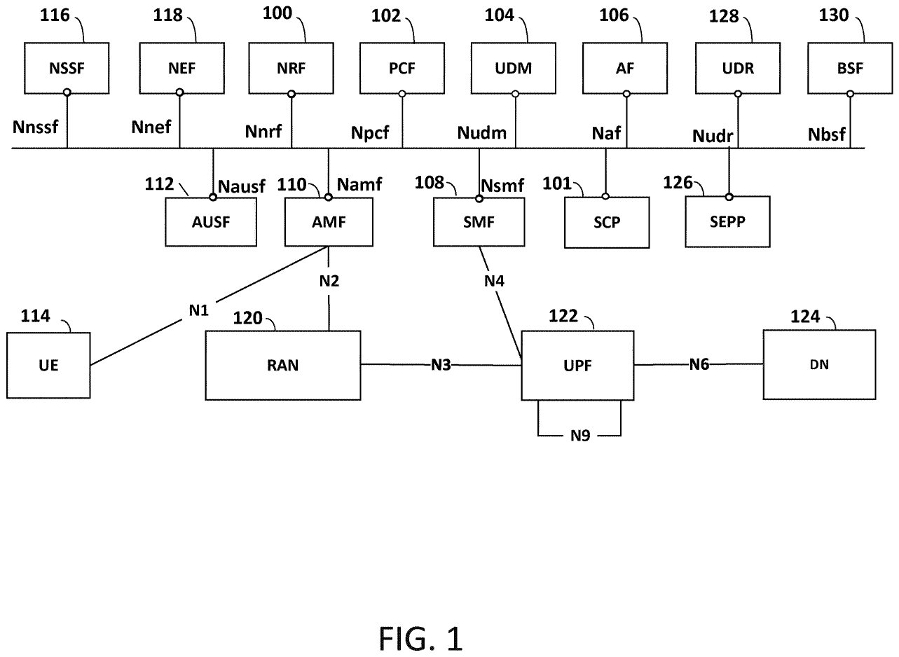

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a PCF 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A UDR 128 stores subscription data for UEs. A binding support function (BSF) 130 manages bindings between PDU sessions and PCFs.

As stated above, one problem that may occur in 5G and other types of networks is that there is the lack of a specified authorization mechanism when one network supports access-token-based authorization and another network does not support access-token-based authorization. For example, there are scenarios in which a visited network may implement OAuth token-based authorization, and the home network may not support OAuth token-based authorization. In such a scenario, if a consumer NF in the visited network fails to obtain an access token form the home network, the consumer NF may not be able to send SBI requests for a roaming subscriber towards the home network, thereby providing a bad user experience to the roaming subscriber (although not the roamer's fault). If the access token is not assigned in response to an OAuth Get request, the NF service consumer NF will not be able to send service requests to the home network, which will in-turn halt the roaming scenario for that subscriber. In addition, because the home network does not support access-token-based authorization, without an alternate security mechanism, the home network remains vulnerable to attacks.

To address these and other issues, a solution is provided where the consumer SEPP (C-SEPP) generates a digitally signed access token on behalf of home network when OAuth authorization is not supported by the home network and thus enables the roaming subscriber to have a better user experience. The C-SEPP also authorizes the consumer NF before providing the SEPP-generated access token to the consumer NF, providing security when the home network does not support OAuth authorization.

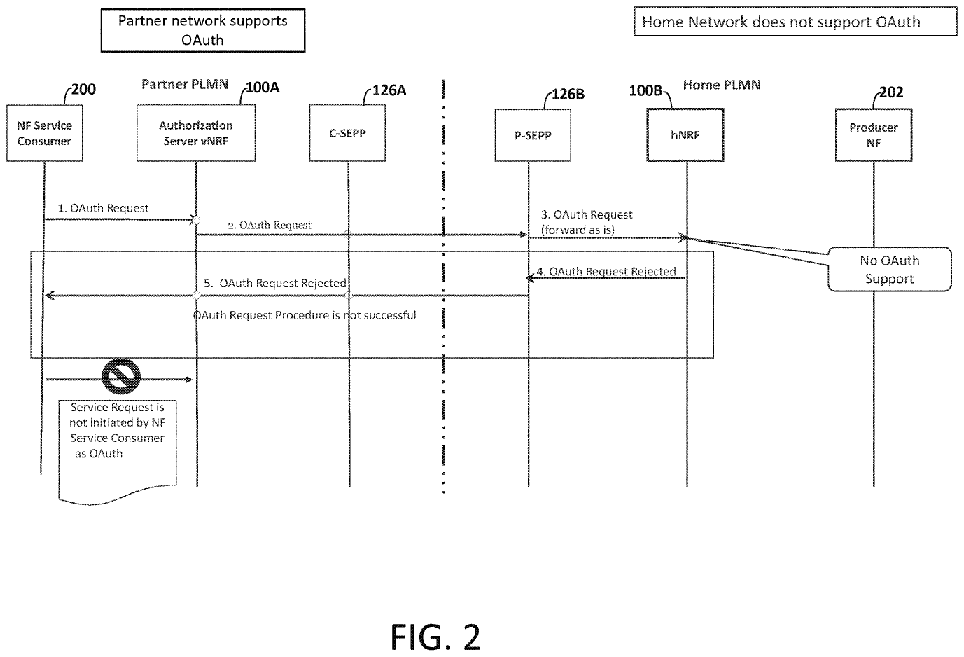

FIG. 2 is a message flow diagram illustrating an exemplary message exchange when a visited PLMN supports access-token-based-authorization and a home network does not support access-token-based authorization. Referring to FIG. 2 in step 1, an NF service consumer 200 in a visited network and seeking to access a service provided by a producer NF 202 located in the home network sends an OAuth (access token) request to a visited NRF (vNRF) 100A. vNRF 100A functions as an OAuth authorization server. vNRF 100A determines that it does not have the access token for the producer NF 202 because producer NF is not registered with vNRF 100A. Accordingly, in step 2, vNRF 100A forwards the OAuth request to the home network. The request traverses C-SEPP 126A, which forwards the request to a producer SEPP (P-SEPP) 126B. In step 3, P-SEPP 126B forwards the OAuth request to a home NRF (hNRF) 100B. In this example, the home network does not support OAuth authorization. Accordingly, in step 4, hNRF 100B generates and sends a message indicating that the OAuth request is rejected. In step 5, P-SEPP 126B sends the message indicating that the OAuth request is rejected to NF service consumer 200. Because the OAuth request is rejected, and NF service consumer 200 supports access-token-based authorization, NF service consumer 200 cannot initiate a service request to producer NF 202.

To address the issue illustrated in FIG. 2, the subject matter described herein includes a solution implemented at the SEPP that leverages the information contained in the AccessTokenReq of 3GPP TS 29.510 (section 6.3.5.2.2). The solution to mitigates security attacks by generating and validating an OAuth token and providing interoperability to the user irrespective of network enforcements. According to the solution, the C-SEPP will register itself with NRF along with NF service consumers. The NRF will assign a client ID to SEPP and consumer NFs, proving their legal identities. The C-SEPP discovers all of the NFs which are allowed to send SBI requests over the N32 interface (e.g., AMF, SMF, etc.) and saves their discovery response details into its database.

The NF service consumer will initiate an Nnrf_AccessToken_Get request towards its local vNRF. The vNRF will authenticate the client (NF service consumer) and forward this request to the hNRF via the C-SEPP. The C-SEPP will save the Nnrf_AccessToken_Get request parameters, such as the NF instance Id, NF consumer type, target NF type, home and serving PLMN IDs etc. locally. The C-SEPP will then forward the Nnrf_AccessToken_Get request to the hNRF via the P-SEPP and wait for its response.

If the Nnrf_AccessToken_Get response is an error message, the C-SEPP interprets the error message as an indication that the home network does not support OAuth authorization. If the home network does not support access token authorization, the C-SEPP will do the following:

The C-SEPP will check whether the NF service consumer is allowed to send the inter-PLMN OAuth request.

The C-SEPP will authorize the client (NF service consumer) by checking details of the NF service consumer saved when the C-SEPP received the Nnrf_AccessToken_Get request message, proving that NF is legal and is also registered with NRF.

The C-SEPP will generate a digitally signed access token and assign the access token to the NF service consumer.

The C-SEPP will send Nnrf_AccessToken_Get response to the vNRF with parameters, such as expires_in and the access token.

If the home network successfully processes the Nnrf_AccessToken_Get request and returns a success response, the home network supports OAuth authorization, and no further action is required on C-SEPP.

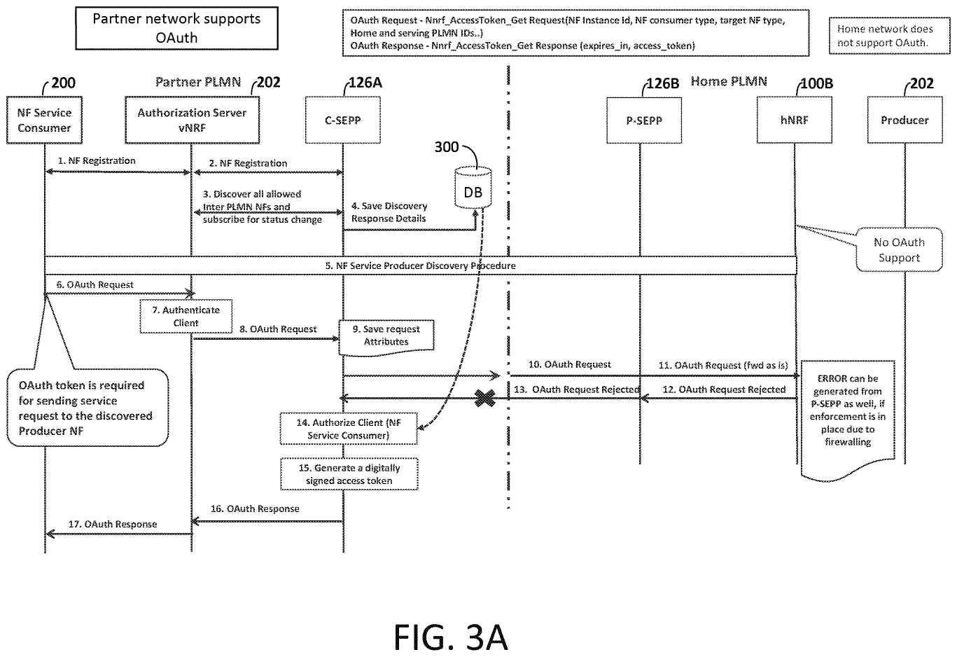

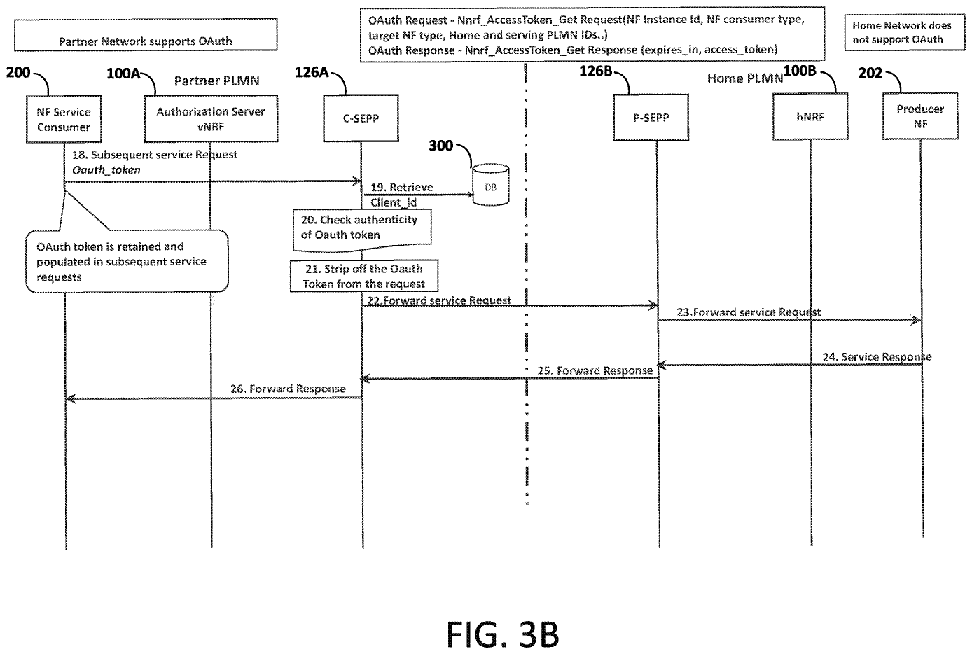

FIGS. 3A and 3B are a message flow diagram illustrating the use of a SEPP to provide network interoperability in the absence of access token authorization support in the home network. Referring to FIG. 3A, in step 1, NF service consumer 200 registers with vNRF 100A. In step 2, C-SEPP 126A registers with vNRF 100A. In step 3, C-SEPP 126A discovers the NF profiles of all NFs that are allowed to send inter-PLMN SBI request messages. C-SEPP 126A also subscribes with vNRF 100A to receive notification of status changes of any of the NF profiles. In step 4, C-SEPP 126A saves the results of the discovery and any status changes in its local NF profiles database 300. In step 5, NF service consumer 200 invokes the NF service discovery procedure and discovers the identity of producer NF 202 for providing a needed service.

In step 6, consumer NF 200 sends and OAuth request to vNRF 100A. In step 7, vNRF 100A authenticates NF service consumer 200. In step 8, vNRF 100A since the OAuth request to C-SEPP 126A. In step 9, C-SEPP 126A saves attributes of the OAuth request. In step 10, C-SEPP 126A forwards the OAuth request to the home PLMN. P-SEPP 126B forwards the OAuth request to hNRF 100B. hNRF 100B does not support OAuth authorization service. Accordingly, in step 12, hNRF 100B sends an error message. P-SEPP 126B receives the error message and forwards the error message to C-SEPP 126A.

In step 13, C-SEPP 126A receives the error message and interprets the error message as an indication the home network does not support OAuth authorization. In step 14, C-SEPP 126A authorizes NF service consumer 200 using the details saved in step 4. In step 15, C-SEPP 126A generates and digitally signs an access token. In step 17, C-SEPP 126A generates an OAuth response including the access token and sends the response to vNRF 100A. In step 17, vNRF 100A forwards the OAuth response to NF service consumer 200.

Referring to FIG. 3B, the message flow from FIG. 3A continues in step 18 where NF service consumer 200 sends an inter-PLMN SBI request message to C-SEPP 126A. In step 19, C-SEPP 126A retrieves the client ID of NF service consumer 200 from NF profiles database 300. In step 20, C-SEPP 126A checks the authenticity of the token by validating the digital signature and the client ID in the token. In step 21, C-SEPP 126A removes the OAuth2.0 access token from the SBI request message. In step 22, C-SEPP 126A forwards the SBI request to P-SEPP 126B. In step 23, P-SEPP 126B forwards the SBI request to producer NF 202. In step 24, producer NF 202 sends a response to the SBI request to P-SEPP 126B. In step 25, P-SEPP 126B forwards the response to C-SEPP 126A. In step 26, C-SEPP 126A forwards the response to NF service consumer 200.

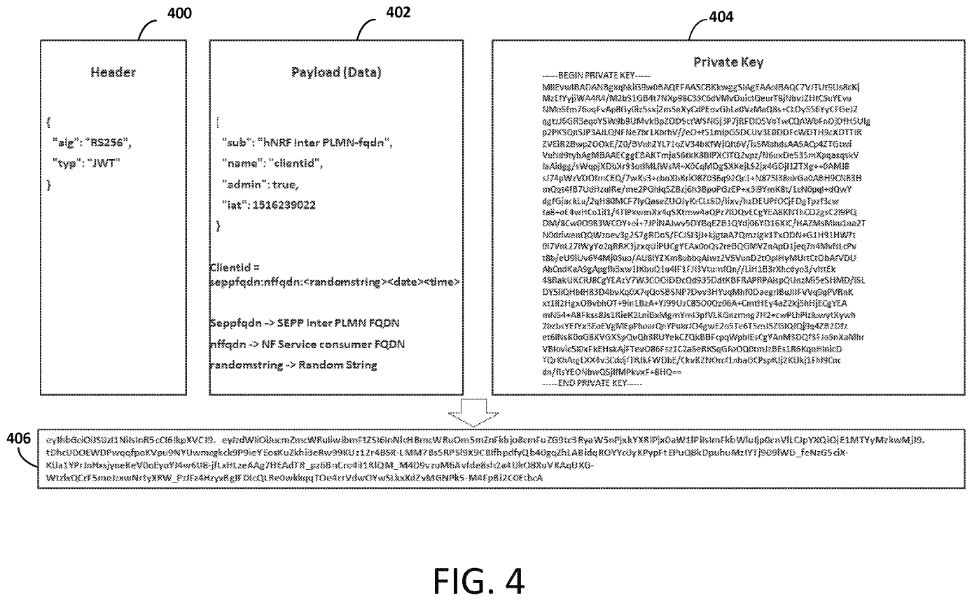

FIG. 4 is a diagram of an access token generated by a SEPP on behalf of a home network NRF that does not support access token authorization. Referring to FIG. 4, the SEPP-generated access token includes a header 400, a payload 402, and a private key 404. Header 400 includes an identifier of the algorithm used to sign the access token and an identifier for the access token type. In the illustrated example, the signature algorithm is RS256 and the access token type is JWT (JavaScript Web Token). Payload 402 contains the payload data for the access token, which in this example includes a subject field that includes a home PLMN identifier and a unique client identifier,. The unique client identifier includes the SEPP FQDN, the FQDN of the client (consumer NF), a random string, and the date and time. The client identifier is used by C-SEPP 126A to validate the access token in a received SBI request message. The access token also includes a signature 406, which is created by signing header 400 and payload 402 using private key 404 of C-SEPP 126A.

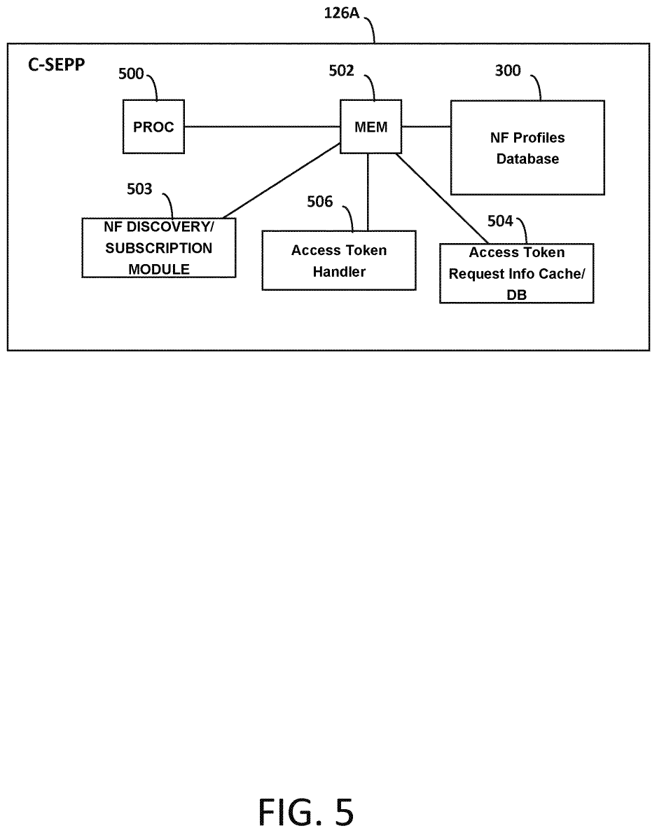

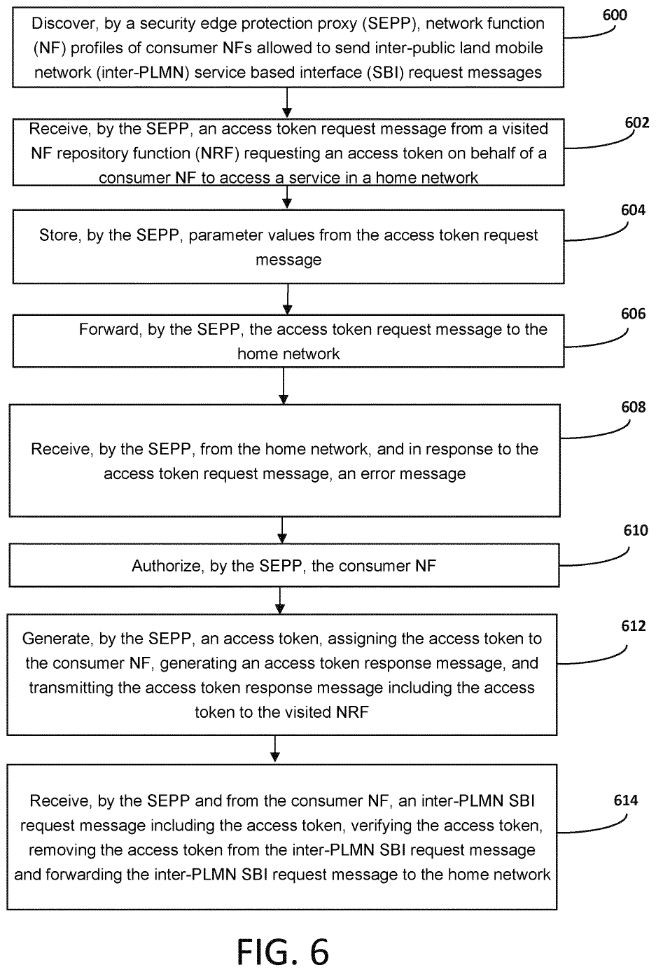

FIG. 5 is a block diagram illustrating an exemplary architecture for a SEPP that provides federated network interoperability in the absence of access token authorization support in the home network. Referring to FIG. 6, C-SEPP 126A includes at least one processor 500 and memory 502. C-SEPP 126A further includes an NF discovery/subscription module 503 that invokes NF discovery and subscription service operations with vNRF 100A and populates an NF profiles database 300 with NF profiles that C-SEPP 126A discovers from vNRF 100A. As indicated above, C-SEPP 126A uses the NF profiles to identify consumer NFs that are allowed (and not allowed) to send inter-PLMN SBI requests. C-SEPP 126A further includes an access token request information cache or database 504 in which C-SEPP 126A stores information from inter-PLMN access token request messages while waiting to determine whether a valid access token response is received. If C-SEPP 126A determines that the destination network does not support access-token-based authorization, C-SEPP 126A uses the information in the access token request information cache or database 504 to create an access token to be sent to the requesting consumer NF. C-SEPP 126A further includes an access token handler 506 that processes access token requests, stores the information from the requests in access token request information cache or database 504, generates access tokens and access token responses, and removes access tokens from SBI request messages destined for networks that do not support access-token-based authorization. Access token handler 506 may be implemented using computer executable instructions stored in memory 502 and executable by processor 500.

FIG. 6 is a flow chart illustrating an exemplary process for providing federated network interoperability in the absence of access token authorization support in the home network. Referring to FIG. 6, in step 600, the process includes discovering, by a security edge protection proxy (SEPP), network function (NF) profiles of consumer NFs allowed to send inter-public land mobile network (inter-PLMN) service-based interface (SBI) request messages. For example, C-SEPP 126A may invoke the NF discovery service operation with vNRF 100A to obtain NF profiles of consumer NFs in the visited network that are allowed to send inter-PLMN SBI request messages.

In step 602, the process includes receiving, by the SEPP, an access token request message from a visited NF repository function (NRF) requesting an access token on behalf of a consumer NF to access a service in a home network. For example, C-SEPP 126A may receive an access token request from vNRF 100A requesting an access token to access a service provided by a producer NF in the home network.

In step 604, the process includes storing, by the SEPP, parameter values from the access token request message. For example, C-SEPP 126A may store parameters from the access token request message in access token request information cache or database 504. Examples of parameter values that can be stored include an NF instance identifier, a consumer NF type identifier, a target NF type identifier, a visited PLMN identifier, and a home PLMN Id

In step 606, the process includes forwarding, by the SEPP, the access token request message to the home network. For example, C-SEPP 126A may forward the access token request to the home network.

In step 608, the process includes receiving, by the SEPP, from the home network, and in response to the access token request message, an error message. In the example illustrated in FIGS. 3A and 3B, the home network does not support access-token-based authorization. Accordingly, the home network (either hNRF 100B or P-SEPP 126B) returns an error response message. It should be noted that if the home network sends an Nnrf_Access_Token_Get response message to vNRF 100A, this means that the home network supports OAuth-based authorization, and no further access token processing (other than forwarding the access token response to vNRF 100A) is required on the part of C-SEPP 126A.

In step 610, the process includes authorizing, by the SEPP, the consumer NF. For example, C-SEPP 126B may authorize consumer NF 200 by determining whether consumer NF 200 is registered with vNRF 100A and is allowed to send the inter-PLMN access token request message.

In step 612, the process includes generating, by the SEPP, an access token, assigning the access token to the consumer NF, generating an access token response message, and transmitting the access token response message including the access token to the visited NRF. For example, C-SEPP 126B may generate an access token including the unique client identifier illustrated in FIG. 4, assign the access token to consumer NF 200 and forward the access token to vNRF 100A in an Nnrf_AccessToken_Get response message to vNRF 100A. vNRF 100A may forward the access token response message to consumer NF 200.

Consumer NF 200 receives the access token response message, reads the access token, formulates an inter-PLMN SBI request message to producer NF 202, and includes the access token in the inter-PLMN SBI request message. In step 614, the process includes receiving, by the SEPP and from the consumer NF, an inter-PLMN SBI request message including the access token, verifying the access token, removing the access token from the inter-PLMN SBI request message and forwarding the SBI request message to the home network. For example, vNRF 100A may receive an inter-PLMN SBI request from consumer NF 200, remove the access token, and forward the inter-PLMN SBI request to the home network.

Exemplary advantages of the subject matter described herein include reducing the likelihood of successful attacks, such as brute force attacks (illegal access token requests) which are initiated from illegal subscribers'/NFs' (serving networks). Another advantage is reducing the likelihood of NF failures resulting from the attaches. Yet another advantage of the subject matter described herein is providing interoperability to the user irrespective of network enforcements. Yet another advantage of the subject matter described herein is that it allows only authenticated requests to pass across the network. Yet another advantage of the subject matter described herein is reducing the likelihood of successful DoS attaches from illegal NFs that are not allowed to send messages over the N32 interface to the home network. Yet another advantage of the subject matter described herein is, by maintaining an NF profiles database at the C-SEPP and subscribing to receive NF profiles updates from the vNRF, avoiding the need to perform NF discover to validate each message from consumer NFs.

One possible alternate solution when the home network does not support OAuth authorization is for the consumer NF in the visited network to treat the failure of the OAuth request to mean that the home network only supports static authorization and have the consumer NF in the visited network send subsequent requests without the OAuth token. One issue with this alternative method is that the consumer NFs in visited networks may handle the error response in different ways. One NF may assume that home network is unable to generate the OAuth token for this request and reinitiate the request. Another NF may assume that the home network does not support OAuth authorization. Such disparate handling of error responses in the visited network would require customized handling and are less desirable that the solution described herein.

The disclosure of each of the following references is incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.4.0 (2025 September); and
2. 3^{rd} Generation Partnership Project; Technical Specification Group Services and System Aspects; Security architecture and procedures for 5G System; (Release 17) 3GPP TS 33.501 V17.0.0 (2020 December)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing federated network interoperability in the absence of access token authorization support in a home network, the method comprising:
discovering, by a security edge protection proxy (SEPP), network function (NF) profiles of consumer NFs allowed to send inter-public land mobile network (inter-PLMN) service-based interface (SBI) request messages;
receiving, by the SEPP, an access token request message from a visited NF repository function (NRF) requesting an access token on behalf of a consumer NF to access a service in a home network;
storing, by the SEPP, parameter values from the access token request message;
forwarding, by the SEPP, the access token request message to the home network;
receiving, by the SEPP, from the home network, and in response to the access token request message, an error message;
authorizing, by the SEPP, the consumer NF;
generating, by the SEPP, an access token, generating an access token response message, and transmitting the access token response message including the access token to the visited NRF; and
receiving, by the SEPP and from the consumer NF, an inter-PLMN SBI request message including the access token, verifying the access token, removing the access token from the inter-PLMN SBI request message and forwarding the inter-PLMN SBI request message to the home network.

2. The method of claim 1 wherein discovering NF profiles of the consumer NFs allowed to send the inter-PLMN SBI request messages includes sending an NF discovery request message to the visited NRF and receiving an NF discovery response message from the visited NRF including NF profiles of the consumer NFs allowed to send the inter-PLMN SBI request messages.

3. The method of claim 2 comprising subscribing, by the SEPP and with the visited NRF, to receive updates to NF profiles of the consumer NFs authorized to send the inter-PLMN SBI request messages.

4. The method of claim 1 wherein receiving the access token request message includes receiving an OAuth2.0 access token request message and generating the access token incudes generating an OAuth2.0 access token.

5. The method of claim 1 wherein storing the parameter values from the access token request message includes storing identification information for the consumer NF in an access token request information cache or database local to the SEPP.

6. The method of claim 1 wherein authorizing the consumer NF by confirming that the consumer NF is registered with the visited NRF and is one of the consumer NFs authorized to send the inter-PLMN SBI request messages.

7. The method of claim 1 wherein generating the access token includes inserting a client identifier in the access token.

8. The method of claim 7 comprising creating the client identifier including information regarding the SEPP, information regarding the consumer NF, and a pseudo-random string.

9. The method of claim 1 comprising, validating, by the SEPP, the access token received in the inter-PLMN SBI request message.

10. The method of claim 9 wherein validating the access token includes determining whether the access token includes a client identifier that matches a client identifier created by the SEPP.

11. A system for providing federated network interoperability in the absence of access token authorization support in a home network, the system comprising:
a computing platform including at least one processor and a memory; and
a SEPP implemented by the at least one processor for discovering network function (NF) profiles of consumer NFs allowed to send inter-public land mobile network (inter-PLMN) service-based interface (SBI) request messages, receiving, an access token request message from a visited NF repository function (NRF) requesting an access token on behalf of a consumer NF to access a service in a home network, storing parameter values from the access token request message, forwarding the access token request message to the home network, receiving, from the home network, and in response to the access token request message, an error message, authorizing the consumer NF, generating, an access token, generating an access token response message, and transmitting the access token response message including the access token to the visited NRF, and receiving, from the consumer NF, an inter-PLMN SBI request message including the access token, verifying the access token, removing the access token from the inter-PLMN SBI request message and forwarding the inter-PLMN SBI request message to the home network.

12. The system of claim 11 wherein the SEPP is configured to discover the NF profiles of the consumer NFs allowed to send the inter-PLMN SBI request messages by sending an NF discovery request message to the visited NRF and receiving an NF discovery response message from the visited NRF including NF profiles of the consumer NFs allowed to send the inter-PLMN SBI request messages.

13. The system of claim 12 wherein the SEPP is configured to subscribe with the visited NRF to receive updates to NF profiles of the consumer NFs authorized to send the inter-PLMN SBI request messages.

14. The system of claim 11 wherein the access token request message comprises an OAuth2.0 access token request message and the generated access token includes an OAuth 2.0 access token.

15. The system of claim 11 wherein the SEPP includes an access token request information cache or database, the SEPP is configured to store the parameter values from the access token request message in the access token request information cache or database, and parameter values from the access token request message include identification information for the consumer NF.

16. The system of claim 11 wherein the SEPP is configured to authorize the consumer NF by confirming that the consumer NF is registered with the visited NRF and is one of the consumer NFs authorized to send the inter-PLMN SBI request messages.

17. The system of claim 11 wherein the SEPP is configured to insert a client identifier in the access token.

18. The system of claim 17 wherein the SEPP is configured to create the client identifier by including, in the client identifier, information regarding the SEPP, information regarding the consumer NF, and a pseudo-random string.

19. The system of claim 11 wherein the SEPP is configured to validate the access token received in the inter-PLMN SBI request by determining whether the access token includes a client identifier that matches a client identifier created by the SEPP.

20. A non-transitory computer readable medium having stored thereon executable instructions that when executed by a processor of a computer control the computer to perform steps comprising:
discovering, by a security edge protection proxy (SEPP), network function (NF) profiles of consumer NFs allowed to send inter-public land mobile network (inter-PLMN) service-based interface (SBI) request messages;
receiving, by the SEPP, an access token request message from a visited NF repository function (NRF) requesting an access token on behalf of a consumer NF to access a service in a home network;
storing, by the SEPP, parameter values from the access token request message;
forwarding, by the SEPP, the access token request message to the home network;
receiving, by the SEPP, from the home network, and in response to the access token request message, an error message;
authorizing, by the SEPP, the consumer NF;
generating, by the SEPP, an access token, generating an access token response message, and transmitting the access token response message including the access token to the visited NRF; and
receiving, by the SEPP and from the consumer NF, an inter-PLMN SBI request message including the access token, verifying the access token, removing the access token from the inter-PLMN SBI request message and forwarding the inter-PLMN SBI request message to the home network.
